(19) United States
(12) Patent Application Publication
(10) Pub. No.: US 2006/0056751 A1
(43) Pub. Date: Mar. 16, 2006

(54) Fluid dynamic bearing

(76) Inventors: Martin Engesser, Donaueschingen (DE); Stefan Schwamberger, Hermsdorf (DE)

Correspondence Address: NORMAN H. ZIVIN;Cooper & Dunham LLP, 1185 Avenue of the Americas, New York, NY, 10036, US

(21) Appl. No.: 11/224,795

(22) Filed: Sep. 13, 2005

(30) Foreign Application Priority Data
Sep. 14, 2004 (DE) 10 2004 044 195.2

(51) Int. Cl. F16C 32/06

(52) U.S. Cl. 384/100

(57) ABSTRACT

The invention relates to a fluid dynamic bearing comprising at least two bearing parts that can move with respect to one another and form a bearing gap filled with a bearing fluid between the associated bearing surfaces. Surface patterns that act on the bearing fluid and generate hydrodynamic bearing pressure within the bearing gap when the bearing parts move with respect to each other are provided. According to the invention, a foil disposed within the bearing gap is provided as a base to carry the surface patterns.

### BACKGROUND OF THE INVENTION

The invention relates to a fluid dynamic bearing, particularly the arrangement and design of the surface patterns that build up hydrodynamic pressure within this kind of bearing.

### PRIOR ART

Hydrodynamic bearings generally comprise at least two bearing parts that are rotatable with respect to each other and form a bearing gap filled with a bearing fluid, e.g. air or bearing oil, between the associated bearing surfaces. Surface patterns that are associated with the bearing surfaces and that act on the bearing fluid are provided, the surface patterns generating hydrodynamic pressure within the bearing gap when the bearing parts rotate or glide with respect to each other.

In fluid dynamic bearings, the surface patterns, or groovings as they are called, are usually formed on individual parts or on several parts. These patterns formed on the appropriate bearing surfaces of the bearing pairs act as bearing or pumping patterns. Known patterns, for example, are a parabola or herringbone pattern for radial bearings and a spiral pattern or a herringbone pattern arranged in a circle for axial bearings.

These patterns are currently formed on the bearing parts by using, for example, an electrochemical process. The known methods of creating bearing patterns are both complex and costly. In addition, the form of the patterns only allows the bearing to operate in one rotational direction when a specific pumping action is required.

### SUMMARY OF THE INVENTION

The object of the invention is thus to provide a hydrodynamic bearing in which the surface patterns provided in the bearing can be more easily fabricated at a lower cost. The aim of a further development of this object is to make it possible for the surface patterns to be so arranged as to allow equivalent operation of the bearing in both rotational directions.

This object has been achieved according to the invention by the characteristics outlined in the independent claims.

Preferred developments and beneficial characteristics of the invention are given in the subordinate claims.

In the fluid dynamic bearing according to the invention, a thin foil disposed within the bearing gap, i.e. between the respective bearing pairs, is provided as a base for the surface patterns. The foil thus acts as a base to carry the pattern. The bearing surfaces are preferably kept free of any kind of pattern. This additional foil component allows the surface patterns, and thus the bearing, to be fabricated more easily and makes it possible to achieve higher precision (tolerance compensation). The patterns can be applied to the foil by means, for example, of stamping, punching, injection-molding or through thermal processes.

This foil-like, patterned bearing part is preferably arranged flexibly within the bearing gap with each bearing surface being located opposite an appropriate side of the foil. In a preferred embodiment of the invention, provision is made for each side of the foil to be given a different surface pattern, and in particular, for each side of the foil to have an identical surface pattern to the other side which, however, is a mirror image of the other side. The different patterning on the inner and outer sides of the foil, or on the top and bottom sides, makes it possible to create fluid dynamic bearings that can be operated in both rotational directions. The respective pressure-building pattern (side of the foil) presses the foil onto the other bearing partner, which additionally generates low pressure, as long as there is a speed difference to the foil. Should this construction be employed in a radial bearing, a sufficiently elastic foil is used allowing it to compensate for the small difference in diameter and differing thermal expansion. Compensation for length, through a slit in the foil for example, can also be provided.

The foil according to the invention acting as a base for the surface pattern can be used for both radial as well as axial bearings. Consequently, the foil can either be annular (cylindrical) in shape or it can also be circular or annulus shaped.

Preferred materials for the foil include plastics or metal.

The bearing according to the invention having the above-described patterned foil can be particularly employed in spindle motors as used to drive the disks in hard disk drives.

Further advantages of the foil according to the invention are found in the fact that by choosing suitable materials for the foil, the start-up and emergency running properties of the fluid dynamic bearing can be improved; furthermore, the bearing can show improved damping.

### BRIEF DESCRIPTION OF THE DRAWINGS

The figures show:

FIG. 1: a schematic view of a radial bearing having a patterned foil according to the invention;

FIG. 2: a schematic view of an axial bearing having a patterned foil according to the invention;

FIG. 3: a patterned component (foil) for a fluid dynamic radial bearing according to FIG. 1 having an outer and inner pattern for both rotational directions;

FIG. 4: a patterned component (foil) for a fluid dynamic axial bearing according to FIG. 2 having patterns for both rotational directions.

### DESCRIPTION OF PREFERRED EMBODIMENTS OF THE INVENTION

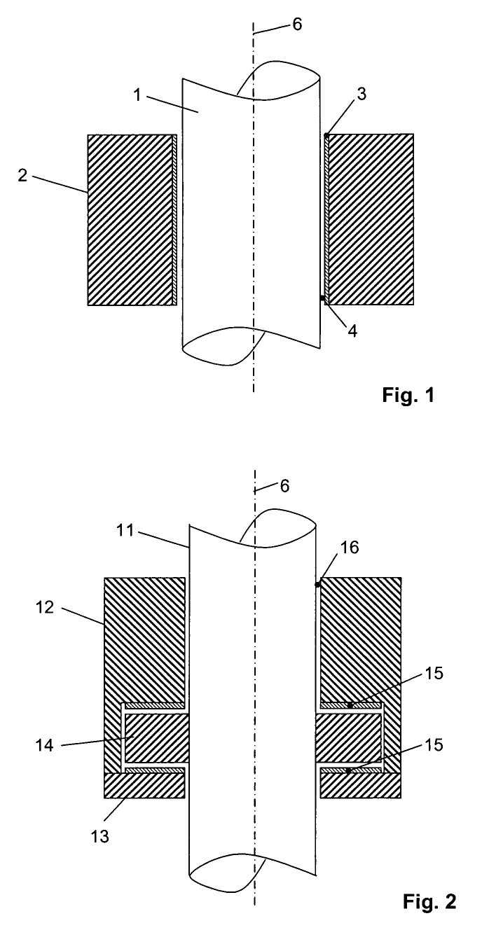

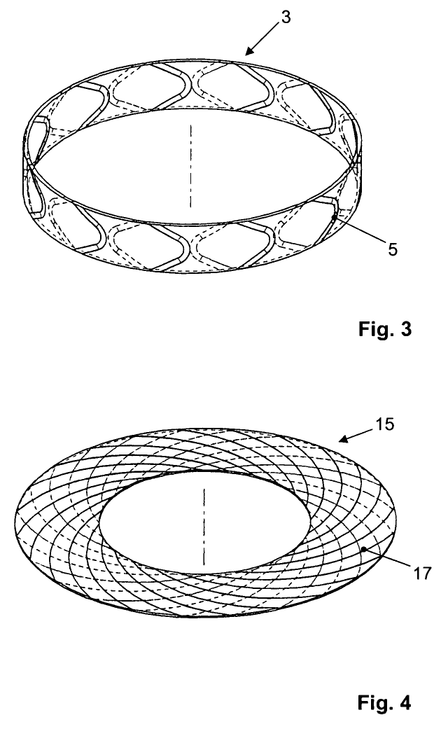

FIG. 1 shows a schematic view of a radial bearing having a patterned foil according to the invention. The radial bearing comprises a shaft 1 that is supported in a bearing bush 2 rotatable about a rotational axis 6. A bearing gap 4 is provided between the two bearing parts 1, 2, the bearing gap 4 being filled with a bearing fluid, preferably a bearing oil, or air as well. A cylinder-shaped patterned foil 3 is inserted into the bearing gap, as shown, for example, in FIG. 3. On each of its sides, the flexible foil 3 has appropriate surface patterns 5 which can take, for example, the form of a parabola, the surface patterns on one side of the foil 3 always running in the opposite direction to the surface patterns on the other side of the foil 3. When the shaft 1 rotates, hydrodynamic bearing pressure is now built up in the bearing fluid within the bearing bush 2 due to the relative movement between parts 1, 2 and the foil 3 and due to the pumping action of the surface patterns 5 on the foil 3, as a result of which the foil is pressed, according to the rotational direction and the alignment of the surface patterns 5, for example, onto the bearing bush 2 and the bearing gap 4 is formed between the foil 3 and the shaft 1. Should the rotational direction of the shaft 1 now be reversed, the hydrodynamic bearing pressure acts in the opposite direction so that in this case, the foil 3 rests against the shaft 1 and the bearing gap 4 is formed between the foil 3 and the bearing bush 2 (not illustrated).

FIG. 2 shows a schematic view of an axial bearing having a patterned foil according to the invention. The axial bearing comprises a shaft 11 supported in a bearing bush 12 rotatable about a rotational axis 6. A thrust plate 14 is firmly fixed to the shaft 11 and accommodated in a recess formed by the bearing bush 12 and a cover plate 13. A bearing gap 16 filled with a bearing fluid is formed between the shaft 11, the bearing bush 12, the cover plate 13 and the thrust plate 14. Two patterned foils 15 are inserted in the bearing gap in the region of the end face of the thrust plate 14, as shown in detail in FIG. 4. The foil 15 is provided with surface patterns 17 on both of its sides.

If the shaft 11, together with the thrust plate 14, is now set in rotation, hydrodynamic bearing pressure is built up in the bearing gap 16 due to the surface patterns 17 on the foil 15, this hydrodynamic bearing pressure pressing, for example, the top foil 15 onto the bearing bush 12 and the bottom foil 15 onto the cover plate 13. If the rotational direction of the shaft 11 or the thrust plate 14 is reversed, the surface patterns 17 act in the opposite direction, i.e. the patterned foils 15 are pressed onto the end faces of the thrust plate 14 (not illustrated). The surface patterns 17 on the foil 15 are, for example, spiral in shape or form a herringbone pattern.

### IDENTIFICATION REFERENCE LIST

1 Shaft
2 Bearing bush
3 Patterned foil
4 Bearing gap
5 Surface patterns
6 Rotational axis
11 Shaft
12 Bearing bush
13 Cover plate
14 Thrust plate
15 Patterned foil
16 Bearing gap
17 Surface patterns

1. A fluid dynamic bearing comprising at least two bearing parts (1,2;11,12, 14) that can move with respect to one another and form a bearing gap (4;16) filled with a bearing fluid between the associated bearing surfaces, surface patterns (5;17) that act on the bearing fluid and generate hydrodynamic bearing pressure within the bearing gap when the bearing parts move with respect to each other being provided,
characterized in that
a foil (3;15) disposed within the bearing gap is provided as a base to carry the surface patterns (5;17)

2. A fluid dynamic bearing according to claim 1, characterized in that the foil (3;15) is flexibly arranged within the bearing gap (4;16).

3. A fluid dynamic bearing according to claim 1, characterized in that each bearing surface (1,2;1 1, 12,13,14) of the bearing parts is located opposite an appropriate side of the foil (3;15).

4. A fluid dynamic bearing according to claim 1, characterized in that each side of the foil (3;15) has a different surface pattern (5;17).

5. A fluid dynamic bearing according to claim 1, characterized in that each side of the foil (3;15) has an identical surface pattern (5;1 7) to the other side which, however, is a mirror image of the other side.

6. A fluid dynamic bearing according to claim 1, characterized in that the bearing is a radial bearing.

7. A fluid bearing according to claim 1, characterized in that the bearing is an axial bearing.

8. A fluid dynamic bearing system according to claim 1, characterized in that the foil (3) takes the form of an annular cylinder.

9. A fluid dynamic bearing according to claim 1, characterized in that the foil (15) is circular or annulus shaped.

10. A fluid dynamic bearing according to claim 1, characterized in that the foil (3; 15) is made of plastics.

11. A fluid dynamic bearing according to claim 1, characterized in that the foil (3;15) is made of metal.

12. A fluid dynamic bearing according to claim 1, characterized in that the surface patterns (5;17) are formed on the foil by means of stamping, punching, injection-molding or through thermal processes.

13. A foil (3) to be inserted into a bearing gap (4;16) between the associated bearing surfaces (1,2;11,12,13,14) of the bearing parts of a fluid dynamic bearing that are moveable with respect to each other,
characterized in that
surface patterns (5;1 7) are provided on their surfaces which develop a pumping action when the bearing parts move with respect to each other and generate hydrodynamic bearing pressure within the bearing gap (4;16).

14. A foil according to claim 13, characterized in that it is made of metal or plastics.

15. A foil according to claim 13, characterized in that each of the sides of the foil has a different surface pattern (5; 17).

16. A foil according to claim 13, characterized in that each of the sides of the foil has an identical surface pattern (5;17) to the other side which, however, is a mirror image of the other side.

17. A foil according to claim 13, characterized in that the foil (3) takes the form of an annular cylinder.

18. A foil according to claim 13, characterized in that the foil (15) is circular or annulus shaped.

19. A foil according to claim 13, characterized in that the surface patterns (5; 17) are formed on the foil by means of stamping, punching, injection-molding or through thermal processes.

20. A spindle motor having a bearing and a foil according to claim 1.

21. A hard disk drive having a spindle motor according to claim 20.
